(19) United States
(12) Patent Application Publication
(10) Pub. No.: US 2007/0100723 A1
(43) Pub. Date: May 3, 2007

(54) System and method for structuring and facilitating financial transactions

(76) Inventor: Michael H. Weiss, Los Angeles, CA (US)

Correspondence Address: IRELL & MANELLA LLP, 1800 AVENUE OF THE STARS, SUITE 900, LOS ANGELES, CA, 90067, US

(21) Appl. No.: 11/266,141

(22) Filed: Nov. 2, 2005

(51) Int. Cl. G06Q 40/00

(52) U.S. Cl. 705/36 R

(57) ABSTRACT

A method and system for creating a “bankruptcy proof” synthetic loan from financial instruments involves creating a schedule of payments due based on a desired loan amount, interest rate, and loan term, and then executing a series swap agreements, each of which is exempt from certain bankruptcy protections, that have predefined payoff amounts on scheduled dates to be paid by the issuer to a holder, in return for a premium paid by the holder to the issuer in exchange for the derivatives. The derivatives may be a series of matching digital option pairs including a call option and a put option with the same strike price, payoff, and expiration. Combinations of various options and swap agreements may be employed to mimic fixed or floating interest rates and other loan characteristics.

### BACKGROUND OF THE INVENTION

1. Field of the Invention

The field of the present invention generally relates to systems and methods for structuring and facilitating financial transactions.

2. Background

The typical means by which lenders provide money to borrowers is through a loan or a line of credit. In general, the lender makes a present transfer of cash to the borrower, who agrees to pay back the borrowed amount over time with interest at a specified rate (either fixed or floating) to compensate the lender for the time value of money. In a typical loan, the borrowed money is paid back in periodic installments. The installments may involve interest-only payments, in which case the original amount borrowed (the “principal”) is paid back in a lump sum at maturity (a balloon payment). In other cases, the principal is paid back over time under a variety of amortizing formulas.

Lenders always face the potential problem that the borrower may declare bankruptcy or otherwise default on the loan. If the borrower files a petition for bankruptcy relief in the United States Bankruptcy Court under Title 11 of the United States Code (the “Bankruptcy Code”), the lender may be precluded from pursuing various legal remedies against the borrower due to operation of the automatic stay provision currently set forth in Bankruptcy Code § 362(a). The stay generally prevents the lender from pursuing certain legal remedies against the borrower (referred to as the “debtor” in the Bankruptcy Code). As a result of the stay, the lender may lose some or all of the balance due on the loan and must compete against other creditors to be repaid on even part of the loan. This can be true even where the lender holds security for the loan. Significantly, the stay prevents the lender from getting immediate access to any collateral pledged by the borrower to secure the loan. In addition, loan payments made to the lender immediately prior to the borrower's bankruptcy could potentially be set aside by the borrower's bankruptcy trustee as “preferential” or “fraudulent” transfers under Bankruptcy Code §§ 544-548. Similarly, Bankruptcy Code § 553places strict limits on the lender's ability to set off claims held by the borrower against the lender.

In short, the risk of a borrower filing bankruptcy is a serious concern for lenders. Even the possible threat posed by the delays and risks of bankruptcy can force lenders to renegotiate loan terms and thus take losses or lose important rights or advantages.

To compensate lenders for the risk of the borrower's bankruptcy, lenders charge a risk premium to borrowers in each loan. The risk premium may manifest as an additional, although non-explicit, interest component in the lender's loan terms or additional interest over and above the risk free rate for the loan. The risk premium varies with the borrower's credit, but all borrowers, except those whose obligations are backed by the full faith and credit of the U.S. Treasury, pay this risk premium as an additional expense of capital, making the loan more expensive, and therefore a disadvantage to borrowers. A secured loan is not a complete solution because the automatic stay in the Bankruptcy Code applies to secured loans.

It would therefore be advantageous to provide a system and method based on an alternative framework for structuring a financial transaction in which money is transferred from one entity (lender) to a second entity (borrower), and then returned in one or more periodic payments to the lender, in a manner that reduces the risks associated with the borrower's potential bankruptcy at a later time. It would further be advantageous to provide a financial structure having less risk for the lender, particularly with respect to a borrower's bankruptcy, and a mechanism for facilitating the creation and implementation of such a financial structure. Such a structure and mechanism would also provide an advantage for borrowers by reducing the costs of financing.

### SUMMARY

The invention in one aspect relates generally to systems and methods for structuring and facilitating financial transactions.

In one embodiment, a method or system for structuring or facilitating a financial transaction involves a means for, or the steps of, structuring a stream of payments based upon one or more financial derivatives (i.e., financial instruments whose values are derived from or dependent upon some other factor or financial instrument) that are exempt from certain restrictions imposed by the Bankruptcy Code once a borrower files for bankruptcy. These derivatives preferably have predefined payoff amounts on scheduled dates to be paid by the issuer of the derivative (i.e., the borrower) to the holder of the derivative (i.e., the lender). At the inception of the transaction, the holder (lender) may transfer a “premium” payment to the issuer/borrower. The premium is an amount that corresponds to the payoffs due under the derivatives.

In a particular embodiment, a method or system for structuring or facilitating a financial transaction involves generating (i) a schedule of payments due based on a desired loan amount, interest rate, and loan term; and (ii) executing one or more financial derivatives whereby the lender becomes a holder of a series of matching put/call option pairs issued by a borrower. In this embodiment, the borrower issues or “writes” option pairs that include a binary put option and a binary call option with the same strike price, payoff, and expiration. At the inception of the transaction, the lender transfers an option premium to the borrower, the premium corresponding to the desired loan amount.

The techniques may be advantageously employed in an automated system for structuring or facilitating a financial transaction. The automated system may include, for example, a user interface for receiving as inputs the specified loan amount, interest rate, and loan term; a payment calculator for determining a schedule of payments due based on the specified loan amount, interest rate, and loan term; and a financial instrument generator for automatically generating a financial instrument documenting a sequence of swap agreements corresponding to the schedule of payments, such as a plurality of matching binary put/call option pairs in favor of the lending entity and issued by the borrower.

Further embodiments, variations and modifications are also disclosed herein.

### BRIEF DESCRIPTION OF THE DRAWINGS

FIG. 1 is a process flow diagram illustrating an example of a technique for structuring or facilitating a financial transaction in accordance with one embodiment as disclosed herein.

FIG. 2 is a more detailed process flow diagram illustrating a particular technique for structuring or facilitating a financial transaction in accordance with the general principles of FIG. 1.

FIG. 3 is a top-level functional diagram of a system for structuring or facilitating a financial transaction in accordance with one embodiment as disclosed herein.

FIG. 4 illustrates an example of a screen layout for inputting loan information, along with the particulars of an illustrative transaction, as may be employed in one or more embodiments of a system for structuring or facilitating financial transactions as disclosed herein.

FIG. 5 is a chart illustrating an example of how a series of options generated from the transaction in FIG. 4 may become exercisable over time and the respective values thereof.

FIGS. 6A and 6B collectively depict an example of a confirmation letter as may be automatically generated, for example, in one or more embodiments of a system for structuring or facilitating financial transactions as disclosed herein.

### DETAILED DESCRIPTION OF PREFERRED EMBODIMENTS

According to one or more embodiments as disclosed herein, a system and method is provided for structuring or facilitating financial transactions that includes structuring a schedule of payments from an option issuer (i.e., a borrower) to a holder (i.e., a lender) based upon one or more derivatives (such as certain types of swap agreements) that are chosen because they are exempt from most restrictions upon lenders imposed by the Bankruptcy Code (for example, Bankruptcy Code §§ 362, 365, 544-548and 553). Examples of such derivatives are provided herein. The system and method generally further provides for a premium payment to purchase derivatives and receive a stream of payments on account of those derivatives that correspond to a stream of payments that would be made on a conventional loan of the same amount at a designated interest rate and maturity. The result is what may be colloquially termed a “bankruptcy proof loan.”

In one embodiment, a computerized system is employed to generate a sequence of derivatives that will generate a stream of payments that mimics the stream of payments in a conventional loan based upon a set of particulars input by a user of the method. The user may indicate, for example, a desired loan amount, interest rate, term, periodicity of loan payments, and other relevant particulars. The computerized system may use those inputs to generate a sequence of derivatives that have payoffs that match the stream of payments for a conventional loan having a principal balance equal to the premium paid for the derivatives with a matching maturity, amortization and interest rate. The derivatives may be pre-specified, selected by the user, or else automatically selected from among a predefined group of derivative types, and are generally intended to be of a type such that they are exempt from the restrictions upon lenders imposed by Bankruptcy Code §§ 362, 365, 544-48 and 553.

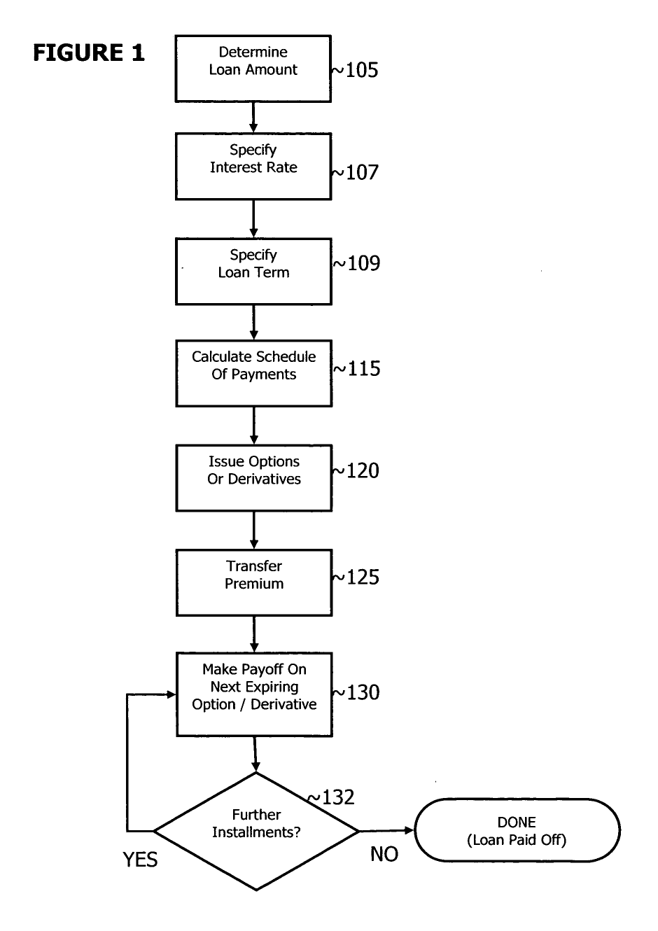

FIG. 1 is a process flow diagram illustrating an example of a technique for structuring or facilitating a financial transaction in accordance with one embodiment as disclosed herein. According to the embodiment illustrated in FIG. 1, a method 100 for structuring or facilitating a financial transaction includes a series of initial steps 105, 107, and 109 according to which a desired loan amount, interest rate, and loan term, respectively, are determined. In a next step 115, a schedule of payments is determined which correspond to the specified loan amount, interest rate, and loan term. Techniques for determining such a schedule of payments, based upon a specified loan amount, interest rate, and term, are well known in the art.

In a next step 120, the putative borrower issues one or more derivatives, selected from a category of derivatives which are generally immune from effect of Bankruptcy Code §§ 362, 365, 544-548and 553, and which the lender holds until expiration thereof. A derivative in this context may be embodied as a swap agreement, as further explained herein. In one embodiment, as will be explained in more detail below, the derivatives are matching pairs of binary put/call currency options having the same strike price, payoff, and expiration.

In a next step 125, the lender transfers a premium corresponding to the desired amount of the loan (i.e., a cash amount, as further explained below) to the borrower. The premium is transferred in exchange for the series of derivatives issued by the borrower to the lender in accordance with step 120. Then, in the following steps 130 and 132, the borrower pays off the derivatives or options as they expire over time, until the last payment is made. The borrower, for example, settles each option as it comes due by making appropriate payment to the lender. The derivatives are structured to provide known periodic payments, the borrower thus makes periodic payments to the lender that mimic the stream of payments from a conventional loan. The result is a “synthetic” loan based upon a series of derivatives that mimic a conventional loan having a specified principal balance, interest rate, and term.

A preferred embodiment, as noted, makes use of certain types of derivatives known as swap agreements and, more specifically, certain types of options (a form of swap agreement under the Bankruptcy Code). Generally, an option is a contract, or a provision of a contract, that gives one party (known as the option holder) the right, but not the obligation, to purchase or sell an asset at a specified price on or before a certain date. An option to buy is called a “call.” An option to sell is called a “put.” The part having the obligation under an option is a “writer.” The party have the right under the option is a “holder.” Option contracts are derivatives. The underlying asset or index from which the option derives its value is referred to as the “underlier.” An option gives the holder to buy from or sell to the writer an underlier at a specified price (the “strike price”), on or before a given date (“expiry”)). An option is referred to as being “at-the-money” if the underlier value currently equals the strike price at the time the holder can or does exercise the option. Otherwise, the option is “in-the-money” if it has positive intrinsic value or “out-of-the-money” if it has no intrinsic value at the time the holder can or does exercise the option. A call is in-the-money if the underlier value is above the strike price. A put is in-the-money if the underlier value is below the strike price. The value of a put at expiry is the strike price less the current value of the underlier. The value of a call at expiry is the current value of the underlier less the strike price.

A digital option (sometimes referred to as a binary option) is an option with a fixed payout if the option is in the money at expiry. If the option is out of the money, no payout is made. Such options are referred to as digital because there are only two possibilities at expiration: either the fixed amount is paid out, or else no payment is made. A digital option may be structured as either a put or call. If structured as a call, for example, a fixed payout is made if the underlier is above the strike price at expiration of the option. However, the issuer pays nothing if the call expires with the underlier equal to or less than the strike price. Likewise, if a digital option is structured as a put, a fixed payout is made if the underlier drops below the strike price at the expiration of the option; otherwise the issuer makes no payout.

Binary or digital options can be structured as “European Options” which means that the options can only be exercised at expiry; or they may be structured as “American Options” so that they can be exercised at any time up to the expiration date. Other variations also exist.

A premium is generally charged by the issuer for the benefit of providing the put or call option to the holder. The premium is usually paid up-front by the holder, and is paid regardless of whether the option is ultimately profitable.

Certain types of derivatives are exempt from protections otherwise afforded to debtors. A key insight herein is that a “synthetic” loan may be constructed from instruments which are in essence “bankruptcy proof.”

The Bankruptcy Code provides that certain types of financial transactions are not subject to certain legal restrictions that prevent lenders from exercising their remedies against borrowers. In particular, a transaction that can be characterized as a “swap agreement” under present Bankruptcy Code § 101 (53B) is not subject to certain legal protections normally afforded debtors and, for the purposes of the invention herein, may be viewed as effectively “bankruptcy proof.” A swap agreement is a type of derivative legally defined, at present, in Bankruptcy Code § 101 (53B) as (A) an agreement (including terms and conditions incorporated by reference therein) which is a rate swap agreement, basis swap, forward rate agreement, commodity swap, interest rate option, forward foreign exchange agreement, spot foreign exchange agreement, rate cap agreement, rate floor agreement, rate collar agreement, currency swap agreement, cross-currency rate swap agreement, currency option, any other similar agreement (including any option to enter into any of the foregoing); (B) any combination of the foregoing; or (C) a master agreement for any of the foregoing together with all supplements.

A swap agreement generally involves the exchange of payments between two or more parties. The payments are based on the change in the value or performance of an asset or index. The amount of the payments is multiplied by some agreed upon sum (the “notional amount”). The value of the swap is typically the difference between the present values of the two sets of payments.

As noted above, a transaction which can be characterized as a swap agreement under the Bankruptcy Code is not subject to certain legal protections normally afforded debtors. For example, if a transaction qualifies as a swap agreement, then the automatic stay provision of Bankruptcy Code § 362(a) would not impair the swap participant's (lender's) rights to its collateral under Bankruptcy Code § 362(b)(17). Cash transfers pursuant to a swap agreement are not treated as preferences or fraudulent transfers under the Bankruptcy Code § 546(g). Moreover, swap agreements cannot be assumed or rejected as executory contracts by a trustee in bankruptcy under Bankruptcy Code § 560. Finally, a swap participant (lender) may exercise set off rights without court approval under Bankruptcy Code § 560. Various aspects of swap agreements and their exemption from certain legal restrictions are more fully detailed in Bankruptcy Code §§ 362(b)(17), 546(g), and 560, all of which are hereby incorporated by reference as if set forth fully herein.

Although the invention herein is described primarily with reference to particular laws and statutes of the United States, it will be understood that the same or similar techniques are applicable in any country having analogous legal provisions. While any type of swap agreement could potentially be used to create a synthetic loan having various advantages to the lender in a bankruptcy context, without limiting the claims made herein below, particular attention will be paid to rate swap agreements, rate cap agreements, rate floor agreements, rate collar agreements, and currency options.

A “rate swap agreement” is generally an agreement between two parties to exchange interest payment due using two different interest rates on the same principal balance. For example, one party will pay the interest due on a fixed rate loan based upon an agreed principal, and the other party will pay the interest due on a floating rate loan based on the same agreed principal balance. The payments are offset against one another and the party with the greater obligation pays the difference. The offset process is called netting. Typically, the parties never exchange the principal amount.

A “rate cap agreement” is an agreement between two parties whereby one party agrees to pay floating interest based on an index (such as the prime rate or LIBOR) to another party, up to an agreed upon maximum rate. It can also be an agreement by which a first party pays a premium to a second party who agrees that, should the index rate rise above a certain level, it will pay the first party the difference between the agreed maximum rate and the rate computed by the index based upon an agreed upon principal balance. Typically, the parties never exchange the principal amount.

A “rate floor agreement” is an agreement between two parties whereby one party agrees to pay floating interest based on an index (such as the prime rate or LIBOR) to another party provided that the rate does not fall below some specified minimum floor. It can also take the form of an agreement whereby a first party pays a premium to a second party who agrees that, should the index rate fall below a certain level, it will pay the first party the difference between the agreed minimum rate and the rate computed by the index based upon an agreed upon principal balance. Typically, the parties never exchange the principal amount.

A “rate collar agreement” is the combination of a rate floor agreement with a rate cap agreement.

A “currency option” is the right to purchase (call) or the right to sell (put) a specified amount of one currency based upon the exchange between that currency and another on or before a specific date when the option expires or, alternatively, only on the date that the option expires.

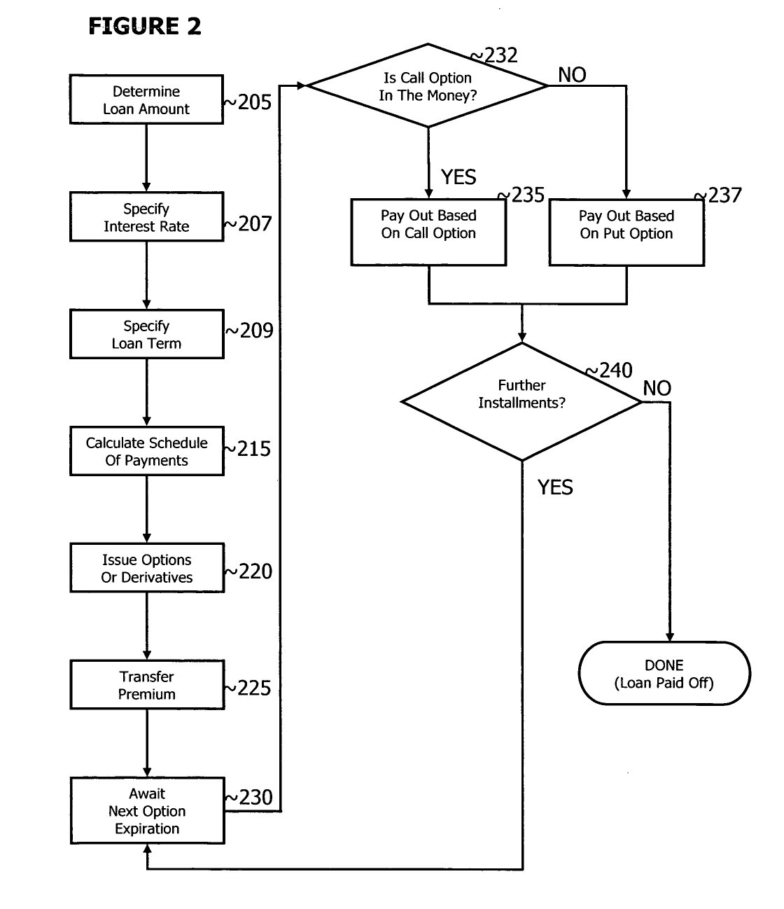

FIG. 2 is a more detailed process flow diagram illustrating a particular technique for structuring or facilitating a financial transaction in accordance with the general principles of FIG. 1. In the example of FIG. 2, the primary instrument being used to create a synthetic bankruptcy proof loan is a structure based on matching pairs of currency options. Similar to the method 100 described with respect to FIG. 1, the method 200 in FIG. 2 for structuring or facilitating a financial transaction includes a series of initial steps 205, 207, and 209 according to which a desired loan amount, interest rate, and loan term, respectively, are determined. In a next step 215, a schedule of payments is determined which correspond to the specified loan amount, interest rate, and loan term. As previously noted, techniques for determining such a schedule of payments, based upon a specified loan amount, interest rate, and term, are well known in the art.

In a next step 220, the borrower issues a series of matching options, falling within a category of options that are generally immune from bankruptcy protections normally afforded to a debtor. The lender holds the options until expiry and is periodically paid by the borrower as the options expire. In one embodiment, the options comprise matching pairs of digital put and call options having the same strike price, payoff, and expiry. Such options may be based on a number of different assets or indices, such as stocks, commodities, or currency, for example, so long as they fall within the legal definition of swap agreement provided by the Bankruptcy Code. The payoffs for the options are selected to correspond to periodic payments that would be made under a conventional loan having the specified loan amount, interest rate, and term, based upon the specified installment dates (which correspond to the option expiration dates).

A further explanation of certain types of particularly useful options will now be provided to illustrate additional aspects and embodiments of the invention. As noted, one particular type of digital option is known as a currency option, in which a specified foreign currency acts as the underlier, with the currency exchange rate reflecting the present value of the currency. An example of a currency option is an agreement where Party A pays Party B a premium for the right to purchase 10,000,000 JPY (Japanese yen) for $80,000 from Party B on a specific date—i.e., the expiration date. This is an example of a call option. Party A is known as the holder of the option and Party B is the writer or issuer of the option. The option is based on a selected strike price related to the yen/dollar (JPY/$) exchange rate. In this example, the strike price is 125 JPY/$ (125 Japanese yen per dollar), which corresponds to $80,000 for 10,000,000 JPY. If, at the expiration date, the exchange rate is above 125 JPY/$ then the call option is “in the money” and the holder can make a profit equal to the difference between the exchange rate at expiration and the exchange rate (i.e., the strike price) specified in the agreement. Thus, if the exchange rate is 135 JPY/$ at expiration, then Party A's profit would be $5,926. The profit is calculated as follows. First, the value of the relevant currency, 10,000,000 JPY, at the exchange rate of 135 JPY/$ equals $74,074. The option is thus worth the difference between the currency at the strike price ($80,000) and the value of the currency at the current exchange rate ($74,074), which amounts to $5,926 as noted.

If, on the other hand, the exchange rate is less than the strike price of 125 JPY/$ (e.g., say it was 112 JPY/$), then the call option is “out of the money” and Party A would not exercise the option, while Party B gets to keep its premium for writing the option. The value of the option can be very little if the exchange rate is only slightly larger than the strike price. If, for example, the exchange rate at expiration is 125.5 JPY/$, then the call option would be worth only $319. Similarly, the value of the option can be very high if the exchange rate is much higher than the strike price.

An example of a currency option in the form of a put option is an agreement whereby Party A pays Party B a premium for the right to sell 10,000,000 JPY for $80,000 from Party B on a specific date—i.e., the expiration date. Party A is again referred to as the holder of the option and Party B is the writer or issuer of the option. The put option is again based on a selected strike price related to the yen/dollar exchange rate, for example 125 JPY/$. If, at the expiration date, the exchange rate is below 125 JPY/$ then the put option is “in the money” and the holder can make a profit equal to the difference between the exchange rate at expiration and the exchange rate specified in the agreement. Thus, for example, if the exchange rate is 100 JPY/$ at expiration, then Party A's profit would be $20,000. The profit in this case is calculated as follows. First, the value of the relevant currency, 10,000,000 JPY, at the current exchange rate of 100 JPY/$ equals $100,000. The option is thus worth the difference between the value of the currency at the current exchange rate ($100,000) and its value at the strike price ($80,000), which amounts to $20,000 as noted.

If, on the other hand, the exchange rate is greater than the strike price of 125 JPY/$ (e.g., say it was 130 JPY/$), then the put option is “out of the money” and Party A would not exercise that option, while Party B gets to keep its premium for writing that option. As with a call option, the value of the put option can be very little if the exchange rate is only slightly below than the strike price. If, for example, the exchange rate at expiration is 124.5 JPY/$, then the option would be worth only $319. Similarly, the value of the put option can be very high if the exchange rate is much lower than the strike price.

By convention, a put option is “in the money” at or below the strike price. Conversely, a call option is “in the money” only if it is above the strike price.

Through various common option pricing formulae it is possible to create a synthetic loan from conventional currency options. However, to do so may present some difficult computational problems. These problems can be fully resolved rather simply by using a digital option, which has been briefly and generically explained above. A digital currency option, for example, is just like a common currency option described above with one main exception: the payoff on the option is not based on a formula dependent upon the degree of difference between the exchange rate at expiration and the strike price. Rather, if the exchange rate at expiration is above the strike price (for a call option), then the writer of the call option will pay an agreed upon fixed sum. If not, then just as in a conventional currency option, the option is out of money and the writer pays nothing. Likewise, for a put option, if the exchange rate at expiration is at or below the strike price, then the writer of the put option will pay an agreed upon sum. If not, then just as in a conventional currency option, the option is out of the money and the writer pays nothing.

The specific nature of the binary option allows the creation of a series of cash flows that can be completely determined in advance. A pair of digital options containing a matching put and call having the same strike price, pay off and expiration will produce a sum certain on the expiration of the option pair. If the call option is in the money, then the writer pays the payoff on the call option but not on the put option. Conversely, if the put option is in the money, then the writer pays the payoff on that option but nothing on the call option.

This may be illustrated by a simple example, although more complex structures are possible using other forms of swap agreements. Using matching pairs of digital currency options, a conventional one-year loan with periodic payments and interest can be replicated. Purely for purposes of example, with the understanding that the actual terms of typical loans will be much different, assume the loan amount will be $10,000at a monthly interest rate of 12%, with interest payable monthly and a balloon principal payment of $10,000at the end. Traditionally, the lender would transfer $10,000in cash to the borrower at inception, and the borrower would make 11 payments of $100 and a 12^{th} and final payment of $10,100 (the last month's interest plus the original $10,000principal).

The same stream of payments can be synthesized entirely from digital currency options. The borrower in this case writes 12 matching pairs of digital currency options and receives a premium of $10,000, corresponding to the desired loan amount. Each pair of options contains a digital put option and a digital call option having the same strike price, expiry, and payoff. The first 11 pairs of digital currency options each have a payoff of $100 and expire on the same day (e.g., the first day of each month after the inception of the transaction). The 12^{th} pair of options has a payoff of $10,100 and is paid one year from the inception of the loan.

Whether the exchange rate is above or below the strike price, the payoff will always be the same as a loan of equivalent value to the premium. For example, if the strike price is 125 JPY/$ and the exchange rate is 128 on the first day of a given month, the borrower pays $100 on the call option and $0 on the put option that expire on that day. If the strike price is 125 JPY/$ and the exchange rate is 118 on the first day of the month, however, the borrower then pays $1,000 on the put option and $0 on the call option. No matter how high or low the exchange rate might be when the option expires, the payoff is always the same because one of the options always pays a defined amount and the other pays nothing.

Thus, returning now to the method shown in FIG. 2, and step 220 in particular, the series of put and call option pairs issued by the borrower includes matching pairs of digital options having the same strike price, payoff, and expiry. Each pair of digital options corresponds to an installment that would be due under a loan of the specified amount, at the specified interest rate. The amount that will be paid at the expiration of a given pair of digital options is known in advance because either the digital put or the digital call will be in the money, but both cannot be in the money at the same time. According to one example, the digital option pairs are structured as currency options. Similar synthetic loans can be structured through various combinations of derivatives that include, for example, currency options, cross currency swaps, basis swaps commodity swaps, currency forwards, and currency swaps.

In a next step 225 of FIG. 2, the lender pays the premium for the option pairs to the borrower, with the premium corresponding to the desired original principal balance of the loan.

Then, in the subsequent steps, the borrower (issuer) settles the options depending whether they are in or out of the money, by making periodic payments to the lender (holder) as the options come due. Thus, in steps 230 and 232, a determination is made at the next 20 installment (expiry) period whether a given option in the option pair is “in the money.” In steps 235 and 237, the borrower makes a payment to the lender (holder) on the digital put option or the digital call option, as the case may be. In any event, the borrower (writer) will always pay on only one of the two digital options. The payment will be the same regardless of whether the put or the call is in the money. As reflected by step 240, if the loan is not fully paid off, the borrower continues to make periodic payments over time on the option pairs as they expire over time on the scheduled installment (expiration) dates, until the last payment has been made. The borrower thus settles each option as it comes due by making appropriate payment to the lender (holder).

Because the option pairs are structured to provide known payments at specific intervals, the borrower makes a stream of periodic payments to the lender (holder) exactly equal to the stream of payments for a conventional loan. The result is, in one aspect, a synthetic loan comprised of options (or swap agreements) that mimic a true loan having a specified loan amount, interest rate, and term.

While a particular loan example was provided above, it should be understood by those skilled in the art that the option pairs can be tailored to meet any predefined set of cash flows. Moreover, other additional vehicles, such as interest rate swaps, collars, floors and caps (“rate swaps”), can be used in combination with other swap agreements (such as digital options, forward rate agreements, currency swaps and other similar derivatives) to create a floating rate loan. For instance, using the prior example of an interest-only term loan payable in one year with fixed interest at 12%, a borrower can use rate swaps to synthesize a floating rate loan. In this case, the floating interest rate would vary with an index, such as the prime rate plus a designated spread. To take one example, the prime rate at the inception of the loan is 8%, and the borrower agrees to pay interest at the prime rate plus 4%. This would yield an aggregate initial interest rate of 12%. The borrower and lender would then enter into a rate swap (in addition to the synthetic loan previously described based on, e.g., digital options) whereby the borrower agrees to pay the lender prime rate plus 4% on the principal balance of $10,000, and the lender agrees to pay 12% at a fixed rate. For example if the prime rate is 9% (yielding a 13% annual interest rate in this example due to the 4% spread) then the borrower would owe $108.33 to the lender and the lender would owe $100 to the borrower. Under an industry convention called “netting”, the borrower need only pay the difference ($8.33) to the lender, in addition to the $100 amount paid by the borrower under the synthetic loan. Likewise, if the prime rate is 7% (yielding an 11% annual interest rate in this example due to the 4% spread), the borrower would owe $91.67 to the lender, and the lender would owe $100 to the borrower. Thus, the lender would pay $8.33 to the borrower. This difference would then be netted (deducted) from the $100 due from the borrower to the lender under the synthetic loan described above.

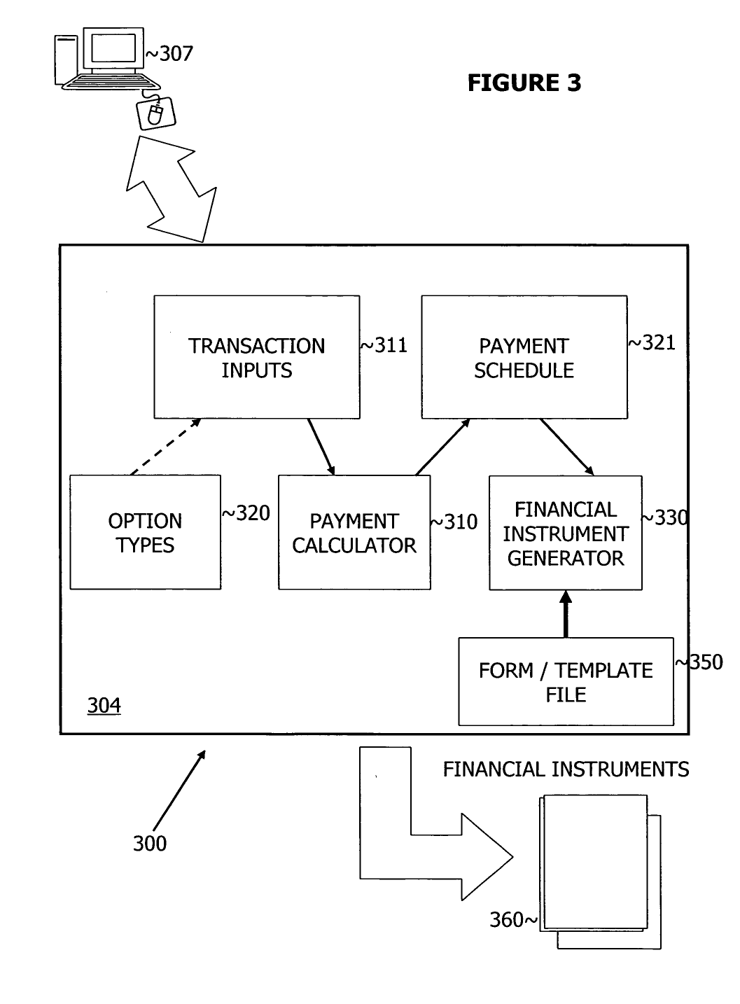

The invention may be implemented, if desired, in connection with an automated system that facilitates the structuring of financial transactions. A preferred automated process may be carried out, for example, by the automated system illustrated in FIG. 3 (described below), may involve a document assembly technique that takes a series of inputs—e.g., loan or premium amount, interest rate, term, installment period, etc.—and in turn generates a set of documents (such as ISDA documents, detailed further herein) that reflect a stream of cash flows derived from the use of swap agreements, which mimic the cash flows of conventional loans. An automated software program for implementing such a process may create a sequence of matching option pairs that mimics a conventional loan, whether an interest only loan (fixed or floating) or a fully amortizing loan at a fixed rate. The automated system may generate option pairs or other swap agreement structures, such as cross currency swaps and currency forwards, that have the same cash flows as conventional loans. The system can be implemented to create future advance, floating rates, and/or amortization structures.

FIG. 3 is a top-level functional diagram of such an automated system 300 for structuring or facilitating a financial transaction in accordance with one embodiment as disclosed herein. As shown in FIG. 3, the automated system 300 may include a computer system 304 (which may itself be a network of computers) connecting to a computer terminal 307 (located either locally or remotely) which may provide, for example, a conventional screen/display, keyboard, mouse, and other such tools or components as well known in the art for providing user interaction. Although only a single computer terminal 307 is shown for purposes of illustration, any number of computer terminals may be connected to the computer system 304. Moreover, the computer terminal 307 may connect in any manner, including over a connection of suitable bandwidth and/or a distributed electronic network (such as the Internet, and/or other interconnected electronic networks, whether digital, analog or mixed in nature). The computer terminal 307 may be configured with any suitable operating system and software, including if necessary a web browser or the equivalent.

The automated system 300 preferably comprises certain functional modules, which facilitate the generation of a synthetic loan using swap agreements or other such instruments. Various inputs may be entered via the user interface provided by the computer terminal 307.

For example, a user may input a specified principal amount, interest rate, and term. The user may specify further details such as whether the interest rate is simple or compound; the manner in which the interest rate is compounded; the periodicity of installment payments desired under the loan; whether a balloon payment will be made at the end of the loan; and so on. From the input parameters, particularly the loan amount, interest rate, and term, a payment calculator 310 is configured to determine a schedule of payments that would be due. Such calculations are based on techniques that are well known in the art of finance and lending.

Once the payment schedule has been derived by the payment calculator 310, in certain embodiments, the user may optionally further select, via the interface provided at the computer terminal 307, a specific type or category of derivative, from among a collection of types or categories maintained in a data compilation (e.g., a database or table) 320 at the computer system 304. Then, a financial instrument generator 330 is invoked to automatically generate one or more financial instruments 360 documenting the synthetic loan, in the form of a series of swap agreements such as, for example, digital currency options, cross currency swaps, or currency forward agreements. The financial instrument generator 330 may implement any of the synthetic loan techniques as described elsewhere herein. Thus, based upon the schedule of payments determined by the payment calculator 310, the financial instrument generator 330 may generate one or more financial instruments that reflect a matching pair of digital options for each installment payment that has been calculated, each put and call option in the matching pair having the same strike price, payoff (corresponding to the amount of the installment payment due), and expiry.

The financial instrument generator 330 may further generate documentation that evidences a commitment to transfer a premium corresponding to the desired loan amount from the lending entity to the borrower, as well as various other related documentation such as a collateral agreement (mortgage or security) that secures performance of the borrower's duties under the various swap agreements.

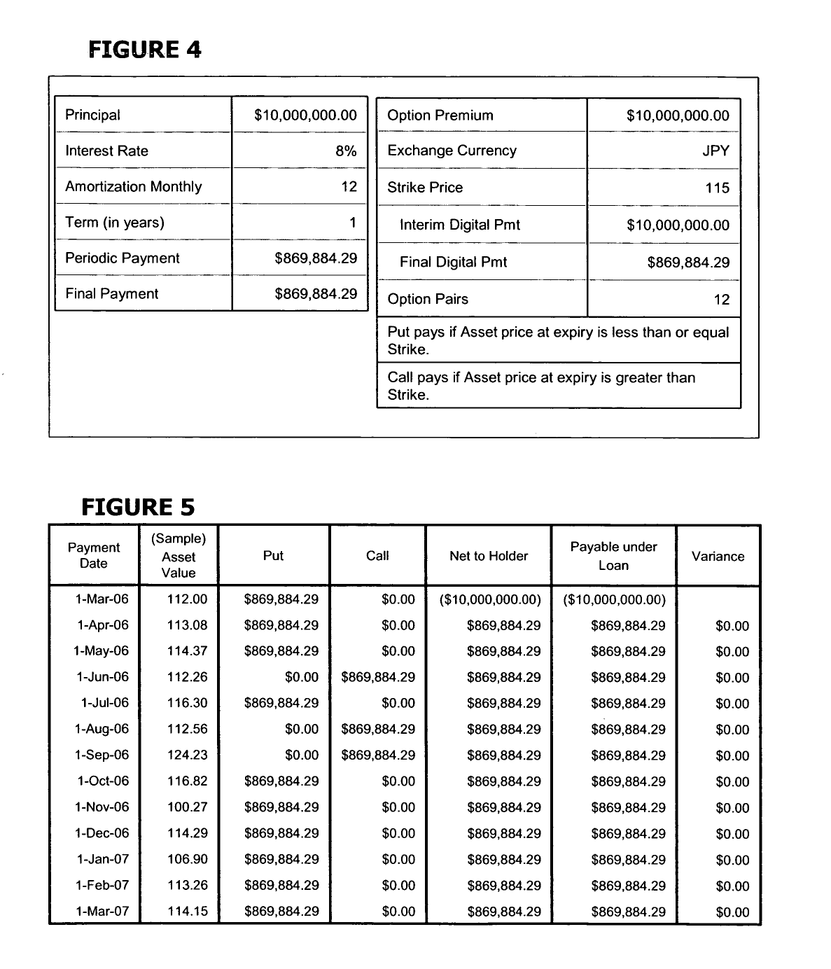

A relatively simple example of a screen layout for inputting loan information, along with the particulars of an illustrative transaction, as may be employed in an automated system such as that shown in FIG. 3, is illustrated in FIG. 4. As shown therein, an interactive screen form, 307 allows the user to enter in a desired loan amount (“principal”) of $10,000,000, at a specified interest rate of 8%, over a monthly amortization period and a specified term of one year. Other input information may also be solicited in the interactive screen form, depending upon the particulars of the loan transaction. For example, the user may specify that the loan be of a particular type (such as an interest only loan). The payment calculator 310 then calculates the periodic payments that would be required in a traditional loan. In this example, the periodic and final payments are illustrated as shown ($869,884.29). In the present example , the original principal due is not displayed in the final payment, although it can be if desired.

The financial instrument generator 330 may then be invoked to generate one or more financial instruments documenting the transaction, according to the specific type of options or other derivatives that have been selected (or else pre-programmed or pre-selected). These parameters are displayed in the sample screen layout of FIG. 4 as well. Here, the transaction is structured as a series of binary currency option pairs. The option premium is $10,000,000—i.e., the same as the desired loan amount. The exchange currency in this case is Japanese yen (JPY). The strike price, in this case 115, may be manually entered, determined randomly, or automatically derived from some source (for example, the current exchange rate, as may be available from many publicly available and electronically accessible sources). The various payments are also illustrated in the sample screen layout, as well as the number of option pairs (or other swap agreements) needed to structure a stream of cash flows comparable to a conventional loan.

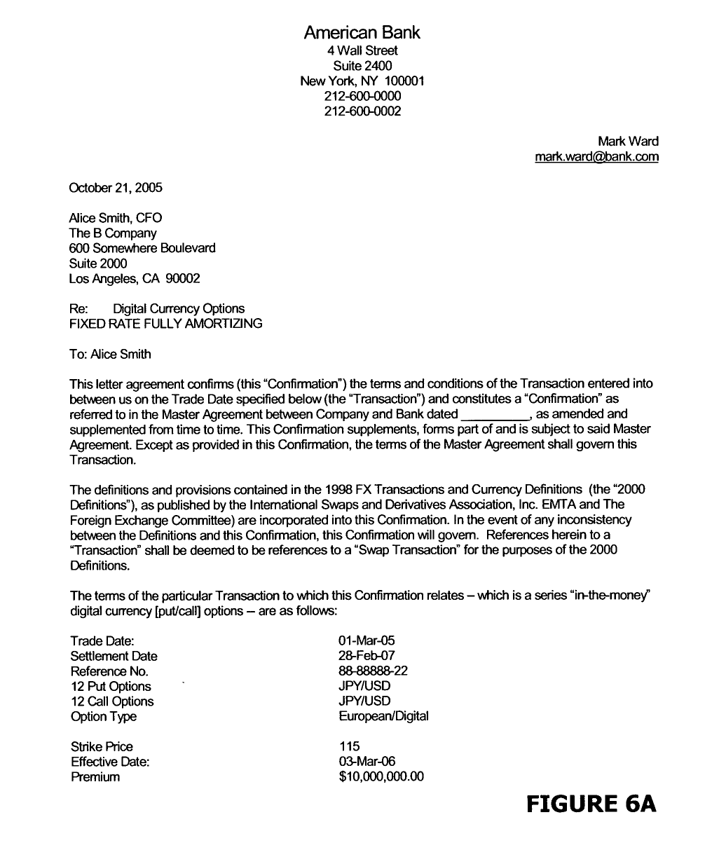

FIG. 5 is a chart illustrating how a series of options generated from the transaction in FIG. 4 may become exercisable over time, and the respective values thereof. As shown in FIG. 5, a series of 12 option pairs have been issued, expiring sequentially month-by-month. Each binary put option and binary call option has a fixed payout of $869,884.29. A sample of the currency fluctuation is illustrated in the second column of the FIG. 5 chart. The Japanese yen in this example starts at 112, then ramps up to 113.08 on April 1, then to 114.37 on May 1, and so on. On the April 1 date, the value of the currency is below the strike price. Therefore, the borrower must pay $869,884.29 on the put option, but pays nothing on the call option. Month by month, the borrower pays out either on the binary put option or the binary call option. The chart of FIG. 5 confirms that the same amount is paid under the series of digital options as would be paid under a standard loan.

Thus, the series of digital options have the same cash flows as a conventional loan.

In a preferred embodiment, the financial instrument generator 330 generates a set of documents that collectively facilitate the financial transaction between lender and borrower. First, the financial instrument generator 330 may generate a master agreement that defines the basic rights and responsibilities of the borrower and lender, as well as the terminology that will govern the transaction. The master agreement may be based on standard forms promulgated by, e.g., the International Swap Derivatives Association (“ISDA”). Members of ISDA include many financial institutions and such members are typically authorized to utilize ISDA documentation. The financial instrument generator 330 may access a form file 350 containing electronically stored templates from which the documentation is to be generated.

The financial instrument generator 330 also preferably generates a credit annex or collateral agreement such as a mortgage or security agreement, which, as noted above, secures performance by the borrower of the various options. Documents for collateralizing the obligations of parties to a swap agreement are generally commercially available (such documents are also promulgated by ISDA). In the automated system 300, such documents may also be stored as templates in the form file 350. The credit annex or collateral agreement may identify collateral (such as real estate, bank accounts, personal assets, etc.) which will secure the options or other derivatives issued by the borrower.

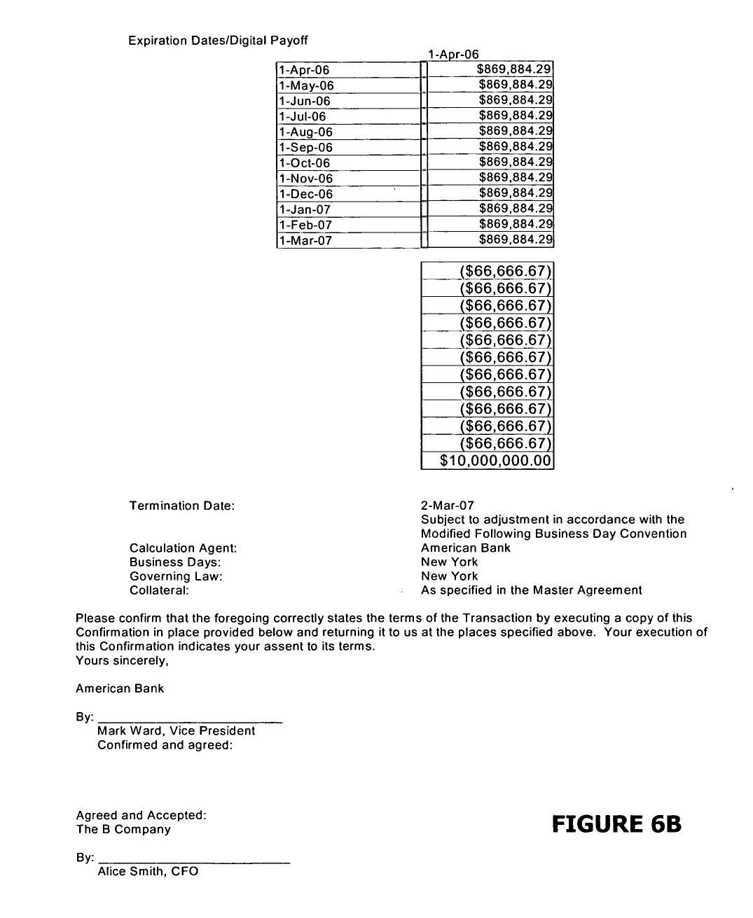

The financial instrument generator 330 may also generate a confirmation letter, an example of which is illustrated in FIGS. 6A and 6B, that may likewise be stored as a template in the form file 350. The confirmation letter can include the basic terms and conditions of the swap agreements being issued by the borrower and the manner in which option values are calculated (according to ISDA or other industry conventions). The confirmation letter confirms the overall agreement between the parties and provides an easily reviewable summary. The particular example in FIGS. 6A and 6B is for an interest only loan, but the confirmation letter can be tailored to the specific transaction.

Any of the documents generated by the financial instrument generator 330 are preferably in a standard computer format such that they can be edited, modified, or otherwise customized using standard word processing programs or any other suitable techniques.

The elements of the automated system 300 shown in FIG. 3, and, in particular, of the main computer system 304, are meant to illustrate the functional components of a preferred embodiment. They are not meant to imply or require a specific software architecture, functional division, hierarchy, or ordering. Those skilled in the art will appreciate that the functional elements of the main computer system 304 can be implemented and organized in a variety of different ways without departing from the scope and spirit of this disclosure.

Although examples have been provided using specific types of swap agreements, such as digital currency options and a variety of other types of swap agreements or combination of swap agreements may be used to provide the benefits of the invention. The lender can transfer (e.g., buy or sell) each of the options (or other swap agreements) issued by a borrower to third parties. Separate entities, if desired, can hold different instruments—for example, one entity may hold all of the puts, and a different entity may hold all of the calls. The options, or other swap agreements, may be traded on over-the-counter markets, as they may have a value after the inception of the synthetic loan that is greater than or less than the amount due on the swap agreement at any one given time.

By virtue of certain methods and techniques described herein, a lender may be provided with a means to structure and carry out a financial transaction in an efficient and convenient manner, having the benefits and equivalent cash flows of a conventional loan with the added benefit of not being subject to the restrictions imposed by Bankruptcy Code §§ 362, 365, 544-548and 553, or other such restrictions as may be legislated from time to time, in the event of the borrower's bankruptcy. If a transaction is structured according to the methods and techniques as disclosed herein and the borrower subsequently files a petition for bankruptcy, the lender, the option or swap agreement participant holder, may pursue its legal remedies against the borrower in collateral legal proceedings despite the existence of the automatic stay provision of the Bankruptcy Code. The lender would therefore be in more advantageous position than in a conventional lending agreement. Payments to the lender prior to the borrower's bankruptcy should be immunized from being avoidable as “preferential” or “fraudulent” transfers. Lenders thus obtain a significant degree of protection and security from a financial transaction structured and carried out as described herein.

Furthermore, because a lender can reduce risk by structuring a synthetic loan as described herein, the lender may be able to offer more advantageous terms to a potential borrower. Lenders often include a risk premium component in the specified interest rate, which represents the degree of risk that the lender takes in making the loan. If the lender's risk is reduced, the lender can pass some or all of the reduction in risk premium on to the borrower. This makes the lender more either more profitable or competitive by being able to reduce the borrower's cost of borrowing money.

While preferred embodiments of the invention have been described herein, many variations are possible which remain within the concept and scope of the invention. Such variations would become clear to one of ordinary skill in the art after inspection of the specification and the drawings. The invention, therefore, is not to be restricted except within the spirit and scope of any appended claims.

What is claimed is:

1. A method for structuring or facilitating a financial transaction, comprising:
structuring a schedule of payments based upon a plurality of financial derivatives to synthesize a series of loan payments, said financial derivatives having predefined payoff amounts on scheduled dates to be paid by the derivative issuer to a holder; and
transferring a premium from the holder to the issuer in return for the financial derivatives, the premium having an amount corresponding to the aggregate payoffs due under said financial derivatives.

2. The method of claim 1, wherein said financial derivatives comprise one or more swap agreements.

3. The method of claim 1, wherein said financial derivatives comprise a series of matching pairs of options, each pair comprising a digital put option and a digital call option having the same strike price, payoff and expiration.

4. The method of claim 1, wherein the payoff amounts of said financial derivatives are based on a desired principal amount, interest rate and loan term, and wherein the premium transferred from the holder corresponds to the principal amount.

5. The method of claim 1, wherein said financial derivatives are selected from the group consisting of: (i) rate swap agreements; (ii) basis swaps; (iii) forward rate agreements; (iv) commodity swaps; (v) interest rate options; (vi) forward foreign exchange agreements; (vii) spot foreign exchange agreements; (viii) rate cap agreements; (ix) rate floor agreements; (x) rate collar agreements; (xi) currency swap agreements, (xii) cross-currency rate swap agreements; (xiii) currency options; (xiv) any option to enter into any of (i) through (xiii); and (xv) any combination of the foregoing.

6. The method of claim 1, wherein said financial derivatives comprise (a) a first plurality of financial derivatives synthesizing payments under a fixed interest rate loan having a specified principal amount, fixed interest rate, and term, and (b) a second plurality of financial derivatives synthesizing a floating interest component on a loan of said principal amount and term.

7. The method of claim 6, wherein said second plurality of financial derivatives comprise one or more rate swap agreements, rate cap agreements, rate floor agreements, or rate collar agreements.

8. An automated system for structuring or facilitating a financial transaction in the form of a synthesized loan, comprising:
a user interface for receiving as inputs a specified loan amount, interest rate, and loan term;
a payment calculator for determining a schedule of payments due based on the specified loan amount, interest rate, and loan term; and
a financial instrument generator for automatically generating a financial instrument documenting a series of swap agreements in favor of a lending entity advancing money to a borrowing entity;
wherein the payoffs under said swap agreements correspond to the payments in the schedule of payments; and
wherein the financial instrument further documents a commitment to transfer a premium corresponding to the desired loan amount from the lending entity to the borrower.

9. The automated system of claim 8, further comprising a financial document generator for generating a collateral agreement securing performance of the options.

9. The automated system of claim 8, wherein said series of swap agreements comprise a series of option pairs.

10. The automated system of claim 9, wherein said option pairs comprise pairs of matching digital currency options, each option pair comprising a digital put option and a digital call option with the same strike price, payoff, and expiration.

11. The automated system of claim 8, wherein said swap agreements are selected from the group consisting of: (i) rate swap agreements; (ii) basis swaps; (iii) forward rate agreements; (iv) commodity swaps; (v) interest rate options; (vi) forward foreign exchange agreements; (vii) spot foreign exchange agreements; (viii) rate cap agreements; (ix) rate floor agreements; (x) rate collar agreements; (xi) currency swap agreements, (xii) cross-currency rate swap agreements; (xiii) currency options; (xiv) any option to enter into any of (i) through (xiii); and (xv) any combination of the foregoing.

12. The automated system of claim 8, wherein said swap agreements comprise (a) a first plurality of financial derivatives synthesizing payments under a fixed interest rate loan having said specified loan amount, a fixed interest rate, and said loan term, and (b) a second plurality of financial derivatives synthesizing a floating interest component.

13. The automated system of claim 12, wherein said second plurality of financial derivatives comprise one or more rate swap agreements, rate cap agreements, rate floor agreements, or rate collar agreements.

14. A method for structuring or facilitating a financial transaction, comprising:
determining a schedule of payments due based on a desired loan amount, interest rate, and loan term;
executing one or more financial instruments whereby a lending entity becomes a holder of a series of matching option pairs issued by a borrower, wherein each option pair comprises a digital put option and a digital call option with the same strike price, payoff, and expiration; and
transferring a premium from the lending entity to the borrower, the premium corresponding to the desired loan amount.

15. The method of claim 14, wherein the payoff amount for a given option pair corresponds to a periodic installment payment for the desired loan amount at the interest rate, according to the specified term.

16. The method of claim 7, wherein said interest rate comprises a floating interest rate component, the method further comprising executing a plurality of swap agreements synthesizing the floating interest rate component.

17. The method of claim 16, wherein said swap agreements comprise one or more rate swap agreements, rate cap agreements, rate floor agreements, or rate collar agreements.

18. A method for synthesizing a loan transaction, comprising:
structuring a schedule of payments based upon a set of financial derivatives exempt from one or more restrictions provided by bankruptcy protections, said financial derivatives having predefined payoff amounts on scheduled dates to be paid by the derivative issuer to a holder based upon a specified loan principal amount and interest rate; and
transferring a premium from the holder to the issuer in return for the financial derivatives, the premium corresponding to the specified principal amount.
